(19) United States
(12) Patent Application Publication
(10) Pub. No.: US 2010/0266861 A1
(43) Pub. Date: Oct. 21, 2010

(54) POWDER FOR MAGNETIC CORE, POWDER MAGNETIC CORE AND THEIR PRODUCTION METHODS

(75) Inventors: Shin Tajima, Nagoya-shi (JP); Masaaki Tani, Nagoya-shi (JP); Daisuke Okamoto, Toyota-shi (JP); Eisuke Hoshina, Toyota-shi (JP); Hidefumi Kishimoto, Susono-shi (JP); Daisuke Ichigozaki, Nagoya-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/740,741

(22) PCT Filed: Oct. 30, 2008
(86) PCT No.: PCT/JP2008/069718

§ 371 Date: May 28, 2010

(30) Foreign Application Priority Data
Nov. 2, 2007 (JP) 2007-286314

(51) Int. Cl. H01F 3/08; B22F 1/02; H01F 41/02

(52) U.S. Cl. 428/546; 427/127; 428/570; 419/66

(57) ABSTRACT

A method for producing a powder for a magnetic core, in which an alkoxide film formation step and a silicone resin film formation step are carried out to form an insulation film composed of an alkoxide film and a silicone resin film on the surface of a pure iron powder, wherein the alkoxide film formation step comprises immersing a pure iron powder in an alkoxide-containing solution which is prepared by mixing a Si alkoxide having at least one organic group having a polar group comprising at least one of N, P, S and O atoms and an Al alkoxide with a dehydrated organic solvent, and drying to remove the dehydrated organic solvent, thereby forming an alkoxide film comprising an Al—Si—O type composite oxide on the surface of the pure iron powder; and the silicone resin film formation step comprises immersing the pure iron powder having the alkoxide film formed thereon in a silicone resin-containing solution which is prepared by mixing a silicone resin with an organic solvent, and drying to remove the organic solvent, thereby forming a silicone resin film on the alkoxide film.

### TECHNICAL FIELD

The present invention relates to a powder for a magnetic core which is prepared by coating a pure iron powder with an insulation film and a powder magnetic core using the powder for a magnetic core, and to their production method.

### BACKGROUND ART

There are many products which utilize electromagnetics including electrical transformers, electric motors, electric generators, speakers, induction heaters and various actuators around us. Many of these products utilize an alternating magnetic field, and are generally provided with a magnetic core (soft magnet) in their alternating magnetic field so as to effectively obtain a locally large alternating magnetic field.

Such magnetic core is first required to provide a high magnetic flux density in an alternating magnetic field in view of its property. Secondly, the magnetic core is required to produce a low high-frequency wave loss according to its frequency when used in an alternating magnetic field. The high-frequency wave loss (iron loss) includes eddy current loss, hysteresis loss and residual loss, and eddy current loss and hysteresis loss are mainly problematic. Furthermore, it is also important that a magnetic core has a small coercive force so as to follow an alternating magnetic field and quickly exhibit a high magnetic flux density. By decreasing the coercive force, improvement of a (initial) magnetic permeability and decreasing of a hysteresis loss can be simultaneously achieved.

However, it is difficult to simultaneously satisfy these requirements, and a sufficient performance could not be obtained by using a simple iron core, a conventional magnetic core formed of lamination of thin silicon steel plates, or the like. Therefore, recently, solution of these problems tends to be achieved by using a powder magnetic core which is obtained by pressure-molding of a magnetic powder (powder for a magnetic core) coated with an insulation film. Namely, each particle in the magnetic powder is coated with an insulation film so as to increase the specific resistance to decrease the high-frequency wave loss of the powder magnetic core, and the magnetic powder is subjected to high pressure molding to obtain a powder magnetic core having a high density so as to increase the magnetic flux density.

For example, many powder magnetic cores which are obtained by using an Fe—Si powder as a magnetic powder, coating the Fe—Si powder with an insulation film composed of a silicone resin, and molding the powder to give a powder magnetic core have been reported (see Patent Documents 1 to 11). Since a high-performance insulation film having properties of a high heat resistance and a high specific resistance is formed on the powder, a high heat resistance and a high specific resistance in a powder magnetic core produced by using the powder can be realized, and an iron loss can further be decreased. Therefore, they are used for high-frequency choke coils or the like.

Patent Document 1: JP-A-2000-30924

Patent Document 2: JP-A-2000-30925

Patent Document 3: JP-A-2000-223308

Patent Document 4: JP-A-2003-297624

Patent Document 5: JP-A No. 2004-288983

Patent Document 6: JP-A-2005-50918

Patent Document 7: JP-A-2005-311196

Patent Document 8: JP-A-2007-194273

Patent Document 9: JP-A-2007-214366

Patent Document 10: JP-A-2007-231330

Patent Document 11: JP-A-2007-231331

### DISCLOSURE OF THE INVENTION

### Problem to be Solved by the Invention

However, when a Fe—Si powder is used, the following problem occurs. Namely, since a Fe—Si powder has higher hardness than that of other magnetic powders such as a pure iron powder, a powder magnetic core obtained by pressure-molding using the Fe—Si powder, has a low molding density. As a result, a problem of decrease in a magnetic flux density occurs.

Therefore, use of a pure iron powder having lower hardness than that of a Fe—Si powder as a magnetic powder is considered. As mentioned above, when a powder magnetic core having a high magnetic flux density is intended to obtain, a high molding density is desired. Considering the lifetime and the like of a molding die, it is desirable to adjust a molding pressure to the lowest possible pressure. Therefore, a pure iron powder having low hardness is suitable for obtaining a powder magnetic core having a high molding density and a high magnetic flux density. Furthermore, a pure iron powder has an advantage that it is industrially desirable due to its lower cost than that of alloy powders such as a Fe—Si powder.

Accordingly, if an insulation film having a high heat resistance and a high specific resistance such as a silicone resin can be formed on a pure iron powder, a powder magnetic core obtained by using the powder for a magnetic core will be an ideal one having a high molding density and a high magnetic flux density, as well as having properties of a high heat resistance, a high specific resistance and a low iron loss.

However, in the past, high performance insulation films to be coated on a pure iron powder have been reported little as compared to that for a Fe—Si powder and the like. For example, even if an insulation film composed of a silicone resin was formed on a pure iron powder in a similar way as formed on a Fe—Si powder, the powder magnetic core obtained by using the powder for a magnetic core could not sufficiently obtain properties of a high heat resistance and a high specific resistance.

Although the reason therefor has not been completely clarified yet, it is supposed as follows. Namely, when a Fe—Si powder is used, an insulation film composed of a silicone resin is uniformly formed due to a high affinity between the silanol group (Si—OH) of the silicone resin and a SiO₂ film formed by natural oxidation which is present on the surface of the Fe—Si powder, and a rigid SiO₂-based film is formed by the reaction between the silicone resin and Si in the Fe—Si powder during heat treatment, whereby an insulation film having a high heat resistance and a high specific resistance is formed. On the other hand, when a pure iron powder is used, the above-mentioned effects as in the case when the Fe—Si powder is used can not be obtained.

The present invention has been made in view of such problems, and aims at providing a powder for a magnetic core and a powder magnetic core using the powder for a magnetic core, and their production methods, which can realize a high heat resistance, a high specific resistance and a low iron loss as well as a high molding density and a high magnetic flux density in a powder magnetic core obtained by pressure-molding.

### Means for Solving the Problem

A first aspect is a method for producing a powder for a magnetic core by coating the surface of a pure iron powder with an insulation film, the method being characterized by carrying out an alkoxide film formation step and a silicone resin film formation step to form an insulation film composed of an alkoxide film as a first layer and a silicone resin film as a second layer on the surface of the pure iron powder, wherein the alkoxide film formation step comprises immersing a pure iron powder in an alkoxide-containing solution which is prepared by mixing a Si alkoxide having at least one organic group having a polar group comprising at least one of N, P, S and O atoms and an Al alkoxide with a dehydrated organic solvent, and drying to remove the dehydrated organic solvent, thereby forming the alkoxide film comprising an Al—Si—O type composite oxide on the surface of the pure iron powder, and the silicone resin film formation step comprises immersing the pure iron powder having the alkoxide film formed thereon in a silicone resin-containing solution which is prepared by mixing a silicone resin with an organic solvent, and drying to remove the organic solvent, thereby forming a silicone resin film on the alkoxide film.

In the method for producing a powder for a magnetic core of the present invention, the alkoxide-containing solution which is prepared by mixing the Si alkoxide and the Al alkoxide with the dehydrated organic solvent is used. Namely, as mentioned below, a solution in which both of Si alkoxide and Al alkoxide have been uniformly dispersed at a molecular level is used. Furthermore, by carrying out the alkoxide film forming step using this alkoxide-containing solution, an alkoxide film comprising an Al—Si—O type composite oxide can be formed uniformly and in the form of a thin film.

Although the specific mechanism thereof has not been clarified yet, it is considered as follows.

Generally, an Al alkoxide forms an oligomer of a dimer to a pentamer in a solvent. Therefore, a solution which is prepared by mixing a general Si alkoxide and Al alkoxide with, for example, an organic solvent is not a solution in which both of Si alkoxide and Al alkoxide have been uniformly dispersed. As a result, only the Al alkoxide which is chemically instable is first hydrolyzed by a trace amount of water in the solution and generates homogeneous nucleation in the solution and converted to a powder. Therefore, an alkoxide film can not be formed uniformly.

On the other hand, the present invention uses a Si alkoxide having at least one organic group having a polar group comprising at least one of N, P, S and O atoms. An alkoxide-containing solution which is prepared by mixing such Si alkoxide and an Al alkoxide with a solvent is a solution in which both of Si alkoxide and Al alkoxide have been uniformly dispersed at a molecular level, since the oligomers of the Al alkoxide are dissociated and converted to monomers, the Si alkoxide coordinates to the Al alkoxide to form a mixed oligomer, and the like.

Furthermore, in the present invention, a dehydrated organic solvent in which water has been removed to the utmost extent is used as a solvent for the reaction solution. Namely, the feature of the present invention is that the adsorbed water and hydroxyl groups on the surface of the pure iron powder to be coated with an insulation film are utilized as water and hydroxyl groups which are required for the reaction of alkoxides.

Generally, it is known that an Al alkoxide is more reactive than those of Si alkoxides such as TEOS (tetraethoxysilane) and TMOS (tetramethoxysilane), and generates a bond (—O—Al—) by a dealcoholization reaction with a hydroxyl group (—OH) without going through processes such as hydrolysis by water and dehydration condensation. Therefore, a so-called sol-gel reaction is caused on the surface of the pure iron powder by the adsorbed water and hydroxyl groups present on the surface.

Furthermore, the Si alkoxide forms a mixed oligomer with the Al alkoxide in the solution. Therefore, the Si alkoxide is also involved in the reaction together with the Al alkoxide.

Accordingly, both of Si alkoxide and Al alkoxide may react on the surface of the pure iron powder to form an alkoxide film composed of an Al—Si—O type composite oxide uniformly and in the form of a thin film.

Furthermore, in the present invention, the silicone resin film forming step is further carried out to form the silicone resin film on the alkoxide film. Namely, since the alkoxide film composed of the Al—Si—O type composite oxide has been already formed uniformly and in the form of a thin film, Si is uniformly present on the surface of the pure iron powder. By forming a silicone resin film on the alkoxide film in such state, a similar effect to that obtained by coating a silicone resin on the Fe—Si powder as in a conventional means can be obtained.

Namely, the effect is, although it is a matter for speculation as mentioned above, that an uniform silicone resin film is formed by the high affinity between the silanol groups (Si—OH) of the silicone resin and the SiO₂ film present on the surface of the Al—Si—O type alkoxide film. Furthermore, the silicone resin reacts with the Si in the alkoxide film during heat treatment to form a rigid SiO₂-type film. As a result, an insulation film composed of the alkoxide film and silicone resin film and having properties of a high heat resistance and a high specific resistance is formed.

Accordingly, a high-performance insulated resin composed of an alkoxide film and a silicone resin film can be formed even in the case when a pure iron powder is used. Furthermore, a formed article obtained by pressure-molding of the powder for a magnetic core (so-called a powder magnetic core) can sufficiently obtain properties of a high heat resistance and a high specific resistance, and can decrease an iron loss.

Furthermore, since a pure iron powder has lower hardness than that of a Fe—Si powder and the like, it can be molded at a high density and can sufficiently maintain properties of a high molding density and a high magnetic flux density.

Thus, according to the production method of the present invention, an insulation film having properties of a high heat resistance and a high specific resistance can be formed on the surface of a pure iron powder. Furthermore, a powder for a magnetic core which can realize a high heat resistance, a high specific resistance and a low iron loss as well as a high molding density and a high magnetic flux density of a powder-compacted magnetic core obtained by pressure-molding can be obtained.

The second aspect is a powder for a magnetic core, characterized in that the powder is produced by the method for producing a powder for a magnetic core of the first aspect.

The powder for a magnetic core of the second aspect is obtained by the method for producing a powder for a magnetic core of the first aspect. Therefore, the powder for a magnetic core can realize a high heat resistance, a high specific resistance and a low iron loss as well as a high molding density and a high magnetic flux density of a formed article (powder magnetic core) obtained by pressure-molding of the powder for a magnetic core.

A third aspect is a method for producing a powder magnetic core, which is characterized by comprising

a filling step for filling the powder for a magnetic core which is produced by the method for producing a powder for a magnetic core of the first aspect in a molding die, and

a molding step for pressure-molding the powder for a magnetic core in the molding die to give a powder magnetic core.

The method for producing a powder magnetic core of the present invention uses a powder for a magnetic core which is produced by the method for producing a powder for a magnetic core of the first aspect. As mentioned above, the powder for a magnetic core can realize a high heat resistance, a high specific resistance and a low iron loss as well as a high molding density and a high magnetic flux density of the powder magnetic core obtained by pressure-molding of the powder for a magnetic core. Therefore, according to the method of the present invention, a powder magnetic core having a high molding density and a high magnetic flux density, as well as a high heat resistance, a high specific resistance and a low iron loss can be obtained.

Ae fourth aspect is a powder magnetic core, characterized in that the powder is produced by the method for producing a powder magnetic core of the third aspect.

The powder magnetic core of the present invention is produced by the method for producing a powder magnetic core of the third aspect. Therefore, the powder magnetic core has a high molding density and a high magnetic flux density, as well as a high heat resistance, a high specific resistance and a low iron loss.

### BRIEF DESCRIPTION OF THE DRAWINGS

FIG. 1 is an explanatory drawing showing the relationship between the formed article density and specific resistance in samples E2 and C1 in the examples.

FIG. 2 is an explanatory drawing showing the relationship between the formed article density and specific resistance in samples E1 and E2 in the examples.

### BEST MODE FOR CARRYING OUT THE INVENTION

In the first aspect, the organic group having a polar group comprising at least one of N, P, S and O atoms in the Si alkoxide is preferably any of an amino group, an amine, an amide, a carbamic acid group, a nitro group, a nitrogen-containing heterocycle, an ammonium salt, a cyano group, an isocyanate group, a carboxyl group, an ester group, aldehydes, ketones, a hydroxy group, an isothiouronium salt, an acid anhydride, a sulfonyl group and a sulfur-containing heterocycle.

In this case, both of Si alkoxide and Al alkoxide in the alkoxide-containing solution can be dispersed more uniformly.

The Si alkoxide can be represented by any of the general formula R¹Si(OR′)₃, R¹R²Si(OR′)₂ or R¹R²R³SiOR′.

As used herein, the R¹ is an organic group having a polar group comprising at least one of N, P, S and O atoms. Furthermore, as the R² and R³, an organic group having a polar group comprising at least one of N, P, S and O atoms similar to the R¹, or other various organic groups can be used.

The OR′ is an alkoxy group. Examples of the OR′ may include a methoxy group (—OCH₃), an ethoxy group (—OC₂H₅—), an isopropoxy group (—OC₃H₇) and the like.

As the Si alkoxide, the followings can be specifically used.

As those having an amino group (—NH₂) or an amine (—NHCH₃ —N(CH₃)₂), 3-aminopropyltriethoxysilane, 3-aminopropyltrimethoxysilane, 3-aminopropyldimethylethoxysilane, 3-aminopropylmethyldiethoxysilane, 4-aminobutyltriethoxysilane, 3-aminopropyldiisopropylethoxysilane, 1-amino-2-(dimethylethoxysilyl)propane, (aminoethylamino)-3-isobutyldimethylmethoxysilane, N-(2-aminoethyl)-3-aminoisobutylmethyldimethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, N-(6-aminohexyl)aminomethyltrimethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, 11-aminoundecyltriethoxysilane, 3-(m-aminophenoxy)propyltrimethoxysilane, m-aminophenyltrimethoxysilane, p-aminophenyltrimethoxysilane, (3-trimethoxysilylpropyl)diethylenetriamine, N-methylaminopropylmethyldimethoxysilane, N-methylaminopropyltrimethoxysilane, dimethylaminomethylethoxysilane, (N,N-dimethylaminopropyl)trimethoxysilane, (N-acetylglycidyl)-3-aminopropyltrimethoxysilane and the like may be used.

As those having an amide (—NH—COR), N-(triethoxysilylpropyl)dansylamide and the like may be used.

Furthermore, as those having a carbamic acid group (—NH—COOR), (O—4-methylcoumarinyl-N-[3-(triethoxysilyl)propyl]carbamate), (3-triethoxysilylpropyl)-t-butylcarbamate, triethoxysilylpropylethylcarbamate, (S)—N-triethoxysilylpropyl-O-menthocarbamate and the like may, be used.

As those having a nitro group (—NO₂), 3-(2,4-dinitrophenylamino)propyltriethoxysilane, 3-(triethoxysilylpropyl)-p-nitrobenzamide and the like may be used.

Furthermore, as those having a nitrogen-containing heterocycle (imidazole, imidazoline, pyridine, pyrrole, aziridine, triazole), N-(3-triethoxysilylpropyl)-4,5-dihydroimidazole (another name: 3-(2-imidazolin-1-yl)propyltriethoxysilane), 2-(trimethoxysilylethyl)pyridine, N-3-trimethoxysilylpropyl)pyrrole, N-[3-(triethoxysilyl)propyl]-2-carbomethoxyaziridine and the like may be used.

Furthermore, as those having an ammonium salt (—[N(CₙH₂ₙ₊₁)₃]⁺Ha⁻, Ha: halogen element), N,N-didecyl-N-methyl-N-(3-trimethoxysilylpropyl)ammonium chloride, octadecyldimethyl(3-trimethoxysilylpropyl)ammonium chloride, tetradecyldimethyl(3-trimethoxysilylpropyl)ammonium chloride, N-(trimethoxysilylethyl)benzyl-N,N,N-trimethylammonium chloride, N-trimethoxysilylpropyl-N,N,N-tri-n-butylammonium bromide, N-trimethoxysilylpropyl-N,N,N-trimethylammonium chloride and the like may be used.

As those having a cyano group (—NC) or an isocyanate group (—N═C═O), 3-cyanopropylphenyldimethoxysilane, 11-cyanoundecyltrimethoxysilane, 3-cyanopropyltrimethoxysilane, 3-cyanopropyltriethoxysilane, 3-isocyanatopropyltrimethoxysilane) and the like may be used.

As those having a carboxyl group (—COOH) or an ester group (—COO—), 3-(tr ethoxysilylpropyl)-2-bromo-2-methylpropionate, triethoxysilylpropylmaleamic acid, 2-(carbomethoxy)ethyltrimethoxysilane and the like may be used.

As those having aldehydes (—CH═O), triethoxysilylbutyraldehyde and the like may be used.

As those having ketones (—(C=O)—R), 2-hydroxy-4-(3-methyldiethoxysilylpropoxy)diphenylketone and the like may be used.

As those having a hydroxyl group (—OH), hydroxymethyltriethoxysilane, N-(hydroxyethyl)-N-methylaminopropyltrimethoxysilane, bis(2-hydroxyethyl)-3-aminopropyltriethoxysilane, N-(3-triethoxysilylpropyl)-4-hydroxybutylamide, 11-(triethoxysilyl)undecanal, triethoxysilylundecanal, ethylene glycol acetal, N-(3-triethoxysilylpropyl)gluconamide and the like may be used.

As those having a isothiouronium salt, N-(trimethoxysilylpropyl) isothiouronium chloride and the like may be used.

As those having an acid anhydride, 3-(triethoxysilyl)propylsuccinic anhydride, 3-(trimethoxysilyl)propylsuccinic anhydride and the like may be used.

As those having a sulfonyl group (—S(═O)₂—), (2-triethoxysilylpropoxy)ethoxysulfolane and the like may be used.

As those having a sulfur-containing heterocycle, 2-(3-trimethoxysilylpropylthio)thiophene and the like may be used.

As the Al alkoxide, aluminum trimethoxide, aluminum triethoxide, aluminium tri-iso-propoxide, aluminium tri-sec-butoxide and the like may be used.

It is preferable that the Si alkoxide is 3-(2-imidazolin-1-yl)propyltriethoxysilane or 3-aminopropyltriethoxysilane, and the Al alkoxide is aluminum tri-sec-butoxide.

In this case, the alkoxide film can be formed on the surface of the pure iron powder more uniformly and in the form of a thin film.

Furthermore, it is preferable that the mixing ratio of the Si alkoxide to the Al alkoxide in the alkoxide-containing solution is in the range of from 0.3:1 to 1:0.3 by molar ratio.

In this case, the alkoxide-containing solution in which the both alkoxides of Si and Al have been dispersed more uniformly can be used in the alkoxide film formation step. Therefore, the alkoxide film can be formed more uniformly.

As the dehydrated organic solvent, a solvent which can dissolve the Si alkoxide and Al alkoxide uniformly and can be readily removed during drying by heating, pressure reduction or the like may be used. Specific examples may include ketones including acetone, methyl ethyl ketone, diethyl ketone, methyl butyl ketone, methyl isobutyl ketone, cyclohexanone and methylcyclohexanone; ethers including ethyl ether, ethylene glycol monobutyl ether, ethylene glycol monoethyl ether acetate, ethylene glycol monobutyl ether and dimethyl ether; cyclic ethers including furan, dibenzofuran, tetrahydrofuran, tetrahydrofuran and dioxane; esters including methyl acetate, ethyl acetate, isopropyl acetate, propyl acetate, butyl acetate, isopentyl acetate and pentyl acetate; amides including N,N-dimethylformamide, dimethylacetamide, methylacetamide, methylformamide, dimethylformamide and

N-methyl-2-pyrrolidone; amines including pyridine, piperidine, pyrimidine and quinoline; nitriles including acetonitrile, propionitrile, isobutyronitrile, phenylacetonitrile and benzonitrile; and sulfoxides including dimethylsulfoxide and methyl phenyl sulfoxide, and they may be used solely or as a mixture of two or more kinds.

It is preferable that the content of water in the dehydrated organic solvent is 0.1% by weight or less.

When the content of water exceeds 0.1% by weight, a sol-gel reaction occurs not on the surface of the pure iron powder, and a precipitate and the like may be produced. Therefore, a step for separating the precipitate and the like is required.

When a solvent having a hydroxyl group (—OH) in the structure such as an alcohol is used as the dehydrated organic solvent, an alcohol interchange reaction with the alkoxy groups in the Si alkoxide and Al alkoxide may occur. During the reaction, a side effect that the solubility of the alkoxides changes and a precipitate is generated may occur. Therefore, it is desirable that the dehydrated organic solvent is non-alcoholic.

Furthermore, it is more preferable to use a hydrophilic polar solvent as the dehydrated organic solvent. This is because that a hydrophilic polar solvent has a fine compatibility with the surface of the pure iron powder having adsorbed water and is more suitable for a surface reaction.

The dehydrated organic solvent may be used as a mixture with a non-polar solvent including halogen type solvents including chloroform, trichloromethane, carbon tetrachloride, 1,2-dichloroethane, 1,2-dichloroethylene, 1,1,2,2-tetrachloroethane and trichloroethylene, and aromatic solvents including benzene, toluene, o-xylene, m-xylene, p-xylene, ethylbenzene and cresol.

The organic solvent used for the preparation of the silicone resin-containing solution may be any one so long it dissolves the silicone resin. The water content in the organic solvent is not specifically limited since the reaction of the alkoxy groups in the first layer has been already completed and an additional reaction of water does not adversely affect the first layer.

The pure iron powder is a magnetic powder which is composed of Fe and inevitable impurities. The pure iron powder is relatively soft, and is excellent in compressibility. Therefore, it is suitable for the production of the powder magnetic core which is formed by pressure-molding of the powder for a magnetic core.

Furthermore, the particle size of the pure iron powder is preferably 10 to 300 μm.

When the particle size of the pure iron powder is less than 10 μm, the hysteresis loss of the powder magnetic core which is obtained by pressure-molding of the powder for a magnetic core may increase. Meanwhile, when the particle size of the pure iron powder is more than 300 the eddy current loss of the powder magnetic core which is obtained by pressure-molding of the powder for a magnetic core may increase.

The pure iron powder is preferably a water-atomized powder or a gas-atomized powder. The water-atomized powder is currently the most available and low in cost. Furthermore, the particles of the water-atomized powder have irregular shapes. Therefore, the mechanical strength of the powder magnetic core which is obtained by pressure-molding of the powder for a magnetic core may be improved.

The gas-atomized powder is composed of approximately spherical particles. Therefore, damages and the like on the insulation film can be suppressed during pressure-molding of the powder for a magnetic core, whereby a powder magnetic core having a high specific resistance can be obtained.

The insulation film is composed of the alkoxide film as a first layer and the silicone resin film as a second layer. The insulation film composed of two layers as referred herein does not necessarily mean that the alkoxide film for the first layer and the silicone resin film for the second layer are discriminated as layers. Therefore, the case when both films blend together to form an insulation film of one layer as a whole is also included.

It is preferable to form a film of a phosphate (for example, Sr—B—P—O type, Fe—P—O type, Mn—P—O type, Ca—P—O type) or the like on the surface of the pure iron powder in advance and form the insulation film thereon.

As the phosphate type film, phosphate type films which are already known (for example, see Shin Tajima et al., “Properties of high density magnetic composite (HDMC) fabricated from iron particles coated with new type phosphate insulator”, Powder and Powder Metallurgy, Japan Society of Powder and Powder Metallurgy, 52-3 (2005), p. 164-170 and the like) may be used.

In this case, the alkoxide film composed of an Al—Si—O type composite oxide can be formed more uniformly with fine adhesibility. As a result, the specific resistance of the powder magnetic core which is obtained by pressure-molding of the powder for a magnetic core can be improved.

In the second aspect, the thickness of the insulation film is preferably from 20 to 3000 nm.

When the thickness of the insulation film is less than 20 nm, a sufficient insulation may not be ensured by the insulation film. Furthermore, the specific resistance of the powder magnetic core which is obtained by pressure-molding of the powder for a magnetic core may be decreased. Meanwhile, when the thickness of the insulation film is more than 3000 nm, the formed article density of the powder magnetic core which is obtained by pressure-molding of the powder for a magnetic core may be decreased, and as a result, the magnetic flux density may be decreased.

It is preferable that the thickness of the alkoxide film is from 10 to 500 nm.

When the thickness of the alkoxide film is less than 10 nm, a sufficiently high specific resistance may not be obtained in the powder magnetic core which is obtained by

pressure-molding of the powder for a magnetic core. On the other hand, when the thickness is more than 500 nm, the formed article density of the powder magnetic core which is obtained by pressure-molding of the powder for a magnetic core may be decreased, and as a result, the magnetic flux density may be decreased.

It is preferable that the thickness of the silicone resin film is from 10 to 2500 nm.

When the thickness of the silicone resin film is less than 10 nm, a sufficiently high specific resistance may not be obtained in the powder magnetic core which is obtained by pressure-molding of the powder for a magnetic core. Meanwhile, when the thickness of the silicone resin film is more than 2500 nm, the formed article density of the powder magnetic core which is obtained by pressure-molding of the powder for a magnetic core may be decreased, and as a result, the magnetic flux density may be decreased.

In the third aspect, it is preferable to use a die-wall lubricating warm compaction method in which the filling step comprises applying a higher aliphatic acid type lubricant to the inner surface of the molding die and filling the powder for a magnetic core in the molding die and the molding step comprises pressure-molding the powder for a magnetic core while heating the powder for a magnetic core and the molding die to provide a powder magnetic core.

In this case, by applying the higher aliphatic acid type lubricant to the inner surface of the molding die in the filling step, a film of a metal salt of the higher aliphatic acid (metal soap film) having an excellent lubricating property is formed between the powder for a magnetic core comprising Fe and the molding die in the molding step. Due to the presence of this metal soap film, galling and the like do not occur, and molding at a higher pressure is possible. Therefore, the mechanical strength of the obtained powder magnetic core can be improved. Furthermore, the life of the molding die can be extended since the powder magnetic core can be removed from the molding die at a very low mold release pressure.

As the higher aliphatic acid type lubricant to be applied, a metal salt of the higher aliphatic acid, as well as the higher aliphatic acid itself are preferable. Examples of the metal salt of the higher aliphatic acid may include a lithium salt, a calcium salt, a zinc salt and the like. Specifically, lithium stearate, calcium stearate and zinc stearate are preferable. In addition, barium stearate, lithium palmitate, lithium oleate, calcium palmitate, calcium oleate and the like may also be used.

It is preferable that an annealing step for annealing the powder magnetic core is carried out after the molding step.

The annealing step is carried out so as to remove the residual stress and residual strain of the powder magnetic core. Accordingly, the coercive force and hysteresis loss of the powder magnetic core are decreased, whereby magnetic properties are improved.

Furthermore, in the annealing step, the annealing temperature is preferably 400° C. or more.

When the annealing temperature is less than 400° C., a sufficient effect of removing the residual stress and residual strain by annealing may not be obtained. Meanwhile, when the annealing temperature is higher than 900° C., deterioration and the like of the insulation film may become easy to proceed.

The heating time in the annealing step is preferably from 1 to 180 minutes.

When the heating time is less than 1 minute, a sufficient effect of removing the residual stress and residual strain by annealing may not be obtained. Meanwhile, when the heating time is more than 180 minutes, a further effect may not be expected even heated, and conversely, the productivity may be decreased.

### Examples

The present invention will be explained with referring to specific examples.

In this example, as shown in the following Table 1, powder magnetic cores using plural kinds of powders for a magnetic core as examples of the present invention (samples E1 to E4), and powder magnetic cores using plural kinds of powders for a magnetic core as comparative examples (samples C1 and C2) were prepared. Furthermore, the powders for a magnetic core which constitute the powder magnetic cores were evaluated by investigating the properties of these powder magnetic cores.

(1) Production of powders for magnetic core

Firstly, two kinds of magnetic powders were prepared. One was a powder obtained by classifying a gas-atomized iron powder manufactured by Sanyo Special Steel Co., Ltd. into from 150 to 212 μm (samples E1 and E4), and the other is a powder obtained by coating the gas-atomized iron powder with a phosphate film in advance (samples E2 and E3).

The iron powder used in the present example was a pure iron powder composed of Fe as a main component and inevitable impurities.

The phosphate film was formed using a similar method to that in a document which has been already disclosed (Shin Tajima et al., “Properties of high density magnetic composite (HDMC) fabricated from iron particles coated with new type phosphate insulator”, Powder and Powder Metallurgy, Japan Society of Powder and Powder Metallurgy, 52-3 (2005), p. 164-170).

Specifically, 0.57 g of strontium carbonate, 0.15 g of boric acid and 1.1 g of phosphoric acid were dissolved in 100 ml of ion exchanged water to prepare a coating liquid. Next, 100 g of iron powder was put into a 500 ml beaker, 20 ml of the coating liquid was further added thereto, and the mixture was stirred lightly. This was subjected to a drying treatment under a condition of nitrogen atmosphere in an inert oven at 120° C. for 1 hour. Thus, a phosphate (Sr—B—P—O type) film having a thickness of 30 nm was formed on the surface of the iron powder.

<Alkoxide film forming step>

Next, in a nitrogen-atmosphere glove box from which moisture had been removed, 100 g of iron powder, 100 ml of dehydrated tetrahydrofuran (hereinafter abbreviated as THF) as an organic solvent, 0.6 g of aminopropyltriethoxysilane as a Si alkoxide, 0.6 g of aluminum isobutoxide as an Al alkoxide were put into a 300 ml flask to prepare an alkoxide-containing solution.

The alkoxide-containing solution was then refluxed for 1 hour in a rotary evaporator under dry nitrogen atmosphere. After the reflux, THF was removed by distillation under a reduced pressure, and a drying treatment was further carried out in an inert oven under nitrogen atmosphere under a condition of 130° C. (samples E3 and E4) or 190° C. (samples E1 and E2) for 2 hours.

Thus, an alkoxide film composed of an Al—Si—O type composite oxide having a thickness of from 30 nm to 100 nm was formed on the surface of the iron powder.

<Silicone resin film forming step>

Next, 50 ml of ethanol as an organic solvent and 0.4 g of a silicone resin were put into the above-mentioned flask to dissolve the silicone resin in the ethanol, and the iron powder on which an alkoxide film had been formed was put into the solution to prepare a silicone resin-containing solution.

In this example, YR3370 manufactured by Momentive Performance Materials, Inc. was used as the silicone resin.

The silicone resin-containing solution was then heated to 170° C. using an external heater while stirring to evaporate ethanol. This drying treatment was carried out for 30 minutes.

Thus, a silicone resin film having a thickness of from 100 to 1000 nm was formed on the alkoxide film formed on the iron powder. Then, a powder for a magnetic core having an insulation film composed of the alkoxide film as a first layer and the silicone resin film as a second layer coated on the iron powder was obtained.

(2) Preparation of powder magnetic core

Powder magnetic cores were prepared using a die-wall lubricating warm compaction method for the obtained various powders for a magnetic core. Specifically, the production of the powder magnetic cores using the die-wall lubricating warm compaction method was performed as follows.

<Filling step>

First, a molding die made of cemented carbide and having a cavity of a desired shape was prepared. The molding die was preheated to 150° C. in a heater. Lithium stearate which had been dispersed in an aqueous solution was uniformly applied to the inner surface of the heated molding die using a spray gun at a ratio of about 1 cm³/sec. The aqueous solution as used herein was prepared by adding a surfactant and a defoaming agent to water.

The various types of powders for a magnetic core were filled in the molding die whose inner surface had been coated with lithium stearate.

As the lithium stearate, one having a melting point of about 225° C. and a particle size of 20 μm was used, and when this was dispersed in the aqueous solution, this was further subjected to refinement in a ball-mill type grinder (Teflon (registered trademark) coated steel ball: 100 hours) and used.

As the surfactant, polyoxyethylene nonyl phenyl ether (EO) 6, polyoxyethylene nonyl phenyl ether (EO) 10 and boric acid ester EMULBON T-80 were used, and as the defoaming agent, FS ANTIFOAM 80 was used.

<Molding step>

Next, the filled various powders for a magnetic core were each subjected to warm pressure-molding at a molding pressure of 1600 MPa as well as the molding die at 150° C. Thus, powder magnetic cores were obtained.

In this molding step using the die-wall lubricating warm compaction method, all powders for a magnetic core did not generate galling and the like with the molding die, and the powder magnetic core could be removed from the molding die at a low mold release pressure of about 5 MPa.

<Annealing step>

Furthermore, in order to remove a molding strain from the obtained various powder magnetic cores, a heat treatment (annealing) was carried out at a condition under nitrogen atmosphere at 600° C. for 1 hours.

Thus, powder magnetic cores prepared by molding the powders for a magnetic core were obtained.

In this example, as comparative samples, a powder for a magnetic core in which only a silicone resin film was formed and an alkoxide film was not formed on an iron powder (sample C1), and a powder for a magnetic core in which only an alkoxide film (drying temperature: 130° C.) was formed and a silicone resin film was not formed on an iron powder (sample C2) were prepared. Furthermore, using these powders for a magnetic core, powder magnetic cores were prepared by a similar method to the above-mentioned method.

(3) Evaluation of powder magnetic core

Using the obtained powder magnetic cores, a formed article density and a specific resistance were evaluated. As the formed article density, a bulk density from a shape was measured. The specific resistance was measured by a four-terminal method using a micro ohm meter (34420A, manufactured by Hewlett-Packard (HP)).

In addition, in this example, a coil was wrapped around a ring-shaped powder magnetic core, and an iron loss Pc, a hysteresis loss Ph and an eddy current loss Pe were measured using a B-H analyzer under the condition of a magnetic flux density of 1T and a frequency of 800 Hz, and a magnetic flux density B_{10K} under the condition of 10 kA/m was measured using a DC magnetic flux meter.

The measurement results are shown in Table 1. The table shows representative values among the measurement results.

TABLE 1

| | | | | Property of Samples | | | | | |
|---|---|---|---|---|---|---|---|---|---|
| | Film | | | Formed | | | | Eddy | |
| | | Alkoxide | | article | Specific | | Hysteresis | current | Magnetic |
| | Phosphoric | (drying | Silicone | density | resistance | Iron loss | loss | loss | flux density |
| | acid | temperature) | resin | (g/cm³) | (μΩm) | Pc(W/kg) | Ph(W/kg) | Pe(W/kg) | B₁₀ₖ(T) |
| Sample E1 | ◯ | ◯ (190° C.) | ◯ | 7.49 | 4100 | 49 | 42 | 7 | 1.36 |
| Sample E2 | X | ◯ (190° C.) | ◯ | 7.50 | 930 | 56 | 43 | 13 | 1.46 |
| Sample E3 | X | ◯ (130° C.) | ◯ | 7.52 | 1600 | 56 | 44 | 12 | 1.47 |
| Sample E4 | ◯ | ◯ (130° C.) | ◯ | 7.51 | 26000 | 53 | 44 | 9 | 1.40 |
| Sample C1 | X | X (—) | ◯ | 7.55 | 60 | 65 | 50 | 15 | 1.59 |
| Sample C2 | X | ◯ (130° C.) | X | 7.70 | 60 | 65 | 50 | 15 | 1.78 |

From the results in Table 1, it was found that the samples E1 to E4 of the examples had a higher specific resistance and a lower iron loss Pc (=hysteresis loss Ph+eddy current loss Pe) as compared to that of the samples C1 and C2 of the comparative examples. Therefore, it was proved that the examples can significantly improve the specific resistance and decrease the iron loss by forming the insulation film composed of the alkoxide film and silicone resin, as compared to the comparative examples in which only the alkoxide film or silicone resin film was formed.

On the other hand, although the samples E1 to E4 of the examples had a slightly lower formed article density and magnetic flux density B_{10K} than those of the samples C1 and C2 of the comparative examples, they still showed a high formed article density and magnetic flux density. Therefore, it was proved that the examples could sufficiently maintain an effect obtained by using a pure iron powder having low hardness, i.e., an effect that the molding may be carried out with a high density and properties of a high molding density and a high magnetic flux density can be obtained.

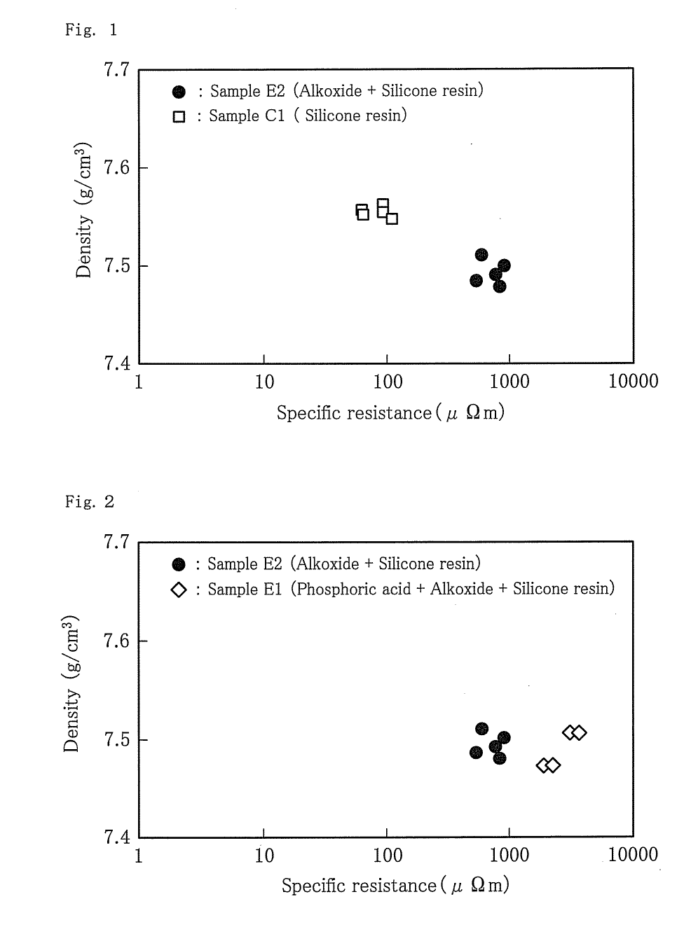

FIG. 1 shows a comparison of the formed article density (g/cm³) and specific resistance (μΩm) between the samples E2 and C1. Namely, the comparison between the samples E2 and C1 corresponds to a comparison between the samples with the alkoxide film and the samples without the alkoxide film.

From the figure, it is recognized that the sample E2 of the examples had a specific resistance of 10 times or higher than that of the sample Cl of the comparative examples due to formation of the alkoxide film.

FIG. 2 shows a comparison of the formed article density (g/cm³) and specific resistance (μΩm) between the samples E1 and E2. Namely, the comparison between the samples E1 and E2 is a comparison between the samples with the phosphoric acid film and the samples without the phosphoric acid film.

From said figure, it is recognized that, by forming the phosphate film, the sample E1 of the example had a specific resistance of about 4 times higher than that not having the phosphate film.

Accordingly, according to the production method of the present example, an insulation film having properties of a high heat resistance and a high specific resistance can be formed on the surface of a pure iron powder. Furthermore, a powder magnetic core which is obtained by pressure-molding can realize a high heat resistance, a high specific resistance and a low iron loss as well as a high molding density and a high magnetic flux density.

1. A method for producing a powder for a magnetic core by coating the surface of a pure iron powder with an insulation film,
the method comprising: carrying out a phosphate type film formation step to form a phosphate type film on the surface of the pure iron powder, and, after the phosphate type film formation step, an alkoxide film formation step and a silicone resin film formation step to form the insulation film composed of an alkoxide film as a first layer and a silicone resin film as a second layer on the surface of the pure iron powder, wherein
the alkoxide film formation step comprises immersing the pure iron powder in an alkoxide-containing solution which is prepared by mixing a Si alkoxide having at least one organic group having a polar group comprising one or a plurality of N, P, S and O atoms and an Al alkoxide with a dehydrated organic solvent, and drying to remove the dehydrated organic solvent, thereby forming an alkoxide film comprising an Al—Si—O type composite oxide on the surface of the pure iron powder; and
the silicone resin film formation step comprises immersing the pure iron powder having the alkoxide film formed thereon in a silicone resin-containing solution which is prepared by mixing a silicone resin with an organic solvent, and drying to remove the organic solvent, thereby forming a silicone resin film on the alkoxide film.

2. The method for producing a powder for a magnetic core of claim 1, wherein the organic group having a polar group comprising at least one of N, P, S and O atoms is any of an amino group, an amine, an amide, a carbamic acid group, a nitro group, a nitrogen-containing heterocycle, an ammonium salt, a cyano group, an isocyanate group, a carboxyl group, an ester group, aldehydes, ketones, a hydroxy group, an isothiouronium salt, an acid anhydride, a sulfonyl group and a sulfur-containing heterocycle.

3. The method for producing a powder for a magnetic core of claim 1, wherein the Si alkoxide is 3-(2-imidazolin-1-yl)propyltriethoxysilane or 3-aminopropyltriethoxysilane, and the Al alkoxide is aluminum tri-sec-butoxide.

4. The method for producing a powder for a magnetic core of claim 1, wherein the mixing ratio of the Si alkoxide to the Al alkoxide in the alkoxide-containing solution is in the range of from 0.3:1 to 1:0.3 by molar ratio.

5. The method for producing a powder for a magnetic core of claim 1, wherein the content of water in the dehydrated organic solvent is 0.1% by weight or less.

6. The method for producing a powder for a magnetic core of claim 1, wherein the particle size of the pure iron powder is from 10 to 300 μm.

7. The method for producing a powder for a magnetic core of claim 1, wherein the pure iron powder is a water-atomized powder or gas-atomized powder.

8. A powder for a magnetic core, wherein the powder is produced by the method for producing a powder for a magnetic core of claim 1.

9. The powder for a magnetic core of claim 8, wherein the thickness of the insulation film is from 10 to 3000 nm.

10. A method for producing a powder magnetic core, by the method comprising
a filling step for filling the powder for a magnetic core which is produced by the method for producing a powder for a magnetic core of claim 1 in a molding die, and
a molding step for pressure-molding the powder for a magnetic core in the molding die to provide a powder magnetic core.

11. The method for producing a powder magnetic core of claim 10, wherein the method uses a die-wall lubricating warm compaction method in which the filling step comprises applying a higher aliphatic acid type lubricant to the inner surface of the molding die and filling the powder for a magnetic core in the molding die and the molding step comprises pressure-molding the powder for a magnetic core while heating the powder for a magnetic core and the molding die to provide a powder magnetic core.

12. The method for producing a powder magnetic core of claim 10, wherein an annealing step for annealing the powder magnetic core is carried out after the molding step.

13. The method for producing a powder magnetic core of claim 10, wherein the annealing temperature is 400° C. or more in the annealing step.

14. A powder magnetic core, which is characterized by that the core is produced by the method for producing a powder magnetic core of claim 10.
